(19) United States
(12) Patent Application Publication
(10) Pub. No.: US 2024/0210514 A1
(43) Pub. Date: Jun. 27, 2024

(54) ENHANCING LOCATION ESTIMATE ACCURACY

(71) Applicant: Lenovo (Singapore) Pte. Ltd., New Tech Park (SG)

(72) Inventors: Robin Thomas, Bad Nauheim (DE); Karthikeyan Ganesan, Kronberg im Taunus (DE)

(21) Appl. No.: 18/555,661

(22) PCT Filed: Apr. 13, 2022
(86) PCT No.: PCT/IB2022/053489

§ 371 Date: Oct. 16, 2023

Related U.S. Application Data
(60) Provisional application No. 63/176,071, filed on Apr. 16, 2021.

(51) Int. Cl. G01S 5/02; G01S 5/00; H04W 64/00

(52) U.S. Cl. CPC G01S 5/021; G01S 5/0036; G01S 5/0218; G01S 5/0236; H04W 64/00

(57) ABSTRACT

Apparatuses, methods, and systems are disclosed for enhancing location estimate accuracy. One method includes transmitting known location information of the device to a location server for the location server to determine correction information. The known location information includes location determination information, 3D location information, a height estimate, and/or a velocity estimate. The method includes receiving assistance data from the location server for performing reference measurements. The method includes receiving a request from the location server to perform the reference measurements based on a configured signaling protocol defined by the location server. The method includes transmitting the reference measurements to the location server based on the configured signaling protocol defined by the location server. The method includes receiving the correction information derived from the location server to enhance a location estimate accuracy for UE based positioning.

### CROSS-REFERENCE TO RELATED APPLICATIONS

This application claims priority to U.S. Patent Application Ser. No. 63/176,071 entitled “APPARATUSES, METHODS, AND SYSTEMS FOR REFERENCE DEVICES FOR ENHANCED ACCURACY” and filed on Apr. 16, 2021 for Robin Thomas et al, which is incorporated herein by reference in its entirety.

### FIELD

The subject matter disclosed herein relates generally to wireless communications and more particularly relates to enhancing location estimate accuracy.

### BACKGROUND

In certain wireless communications networks, reference devices may be used for improving positioning accuracy. In such networks, such reference devices may operate with inefficiencies.

### BRIEF SUMMARY

Methods for enhancing location estimate accuracy are disclosed. Apparatuses and systems also perform the functions of the methods. One embodiment of a method includes transmitting, from a device, known location information of the device to a location server for the location server to determine correction information. The known location information includes location determination information, 3D location information, a height estimate, a velocity estimate, or some combination thereof. In some embodiments, the method includes receiving assistance data from the location server for performing reference measurements. In certain embodiments, the method includes receiving a request from the location server to perform the reference measurements based on a configured signaling protocol defined by the location server. In various embodiments, the method includes transmitting the reference measurements to the location server based on the configured signaling protocol defined by the location server. In some embodiments, the method includes receiving the correction information derived from the location server to enhance a location estimate accuracy for UE based positioning.

One apparatus for enhancing location estimate accuracy includes a transceiver to: transmit known location information of the apparatus to a location server for the location server to determine correction information, wherein the known location information includes location determination information, 3D location information, a height estimate, a velocity estimate, or some combination thereof; receive assistance data from the location server for performing reference measurements; receive a request from the location server to perform the reference measurements based on a configured signaling protocol defined by the location server; transmit the reference measurements to the location server based on the configured signaling protocol defined by the location server; and receive the correction information derived from the location server to enhance a location estimate accuracy for UE based positioning.

Another embodiment of a method for enhancing location estimate accuracy includes receiving, at a location server, known location information from a device for determining correction information. The known location information includes location determination information, 3D location information, a height estimate, a velocity estimate, or some combination thereof. In some embodiments, the method includes transmitting assistance data to the device for performing reference measurements. In certain embodiments, the method includes transmitting a request to the device to perform the reference measurements based on a configured signaling protocol defined by the location server. In various embodiments, the method includes receiving the reference measurements from the device based on the configured signaling protocol defined by the location server. In some embodiments, the method includes deriving the correction information based on the known location information and the reference measurements. In certain embodiments, the method includes transmitting the correction information to the device to enhance a location estimate accuracy for UE based positioning.

Another apparatus for enhancing location estimate accuracy includes a transceiver and a processor coupled to the transceiver. The transceiver to: receive known location information from a device for determining correction information, wherein the known location information includes location determination information, 3D location information, a height estimate, a velocity estimate, or some combination thereof; transmit assistance data to the device for performing reference measurements; transmit a request to the device to perform the reference measurements based on a configured signaling protocol defined by the apparatus; and receive the reference measurements from the device based on the configured signaling protocol defined by the apparatus; the processor to derive the correction information based on the known location information and the reference measurements; and the transceiver to transmit the correction information to the device to enhance a location estimate accuracy for UE based positioning.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for enhancing location estimate accuracy:

FIG. 2 is a schematic block diagram illustrating one embodiment of an apparatus that may be used for enhancing location estimate accuracy:

FIG. 3 is a schematic block diagram illustrating one embodiment of an apparatus that may be used for enhancing location estimate accuracy:

FIGS. 4A and 4B are diagrams illustrating one embodiment of a ProvideCapabilities message:

FIG. 5 is a diagram illustrating one embodiment of a ProvideAssistanceData message:

FIG. 6 is a diagram illustrating another embodiment of a ProvideAssistanceData message:

FIGS. 7A, 7B, and 7C are diagrams illustrating one embodiment of a RequestLocationInformation message:

FIG. 8 is a diagram illustrating one embodiment of a ProvideLocation Information message:

FIG. 9 is a schematic block diagram illustrating one embodiment of a system including a location information transfer procedure using NRPPa and RRC signaling:

FIG. 10 is a diagram illustrating one embodiment of a RefDeviceLocationInfo message:

FIG. 11 is a diagram illustrating one embodiment of a RefDevice Location MeasurementInfo message:

FIG. 12 is a diagram illustrating one embodiment of a NR-UEB-DL-PRS-DifferentialCorrections message for UE-based positioning:

FIG. 13 is a flow chart diagram illustrating one embodiment of a method for enhancing location estimate accuracy; and

FIG. 14 is a flow chart diagram illustrating another embodiment of a method for enhancing location estimate accuracy.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

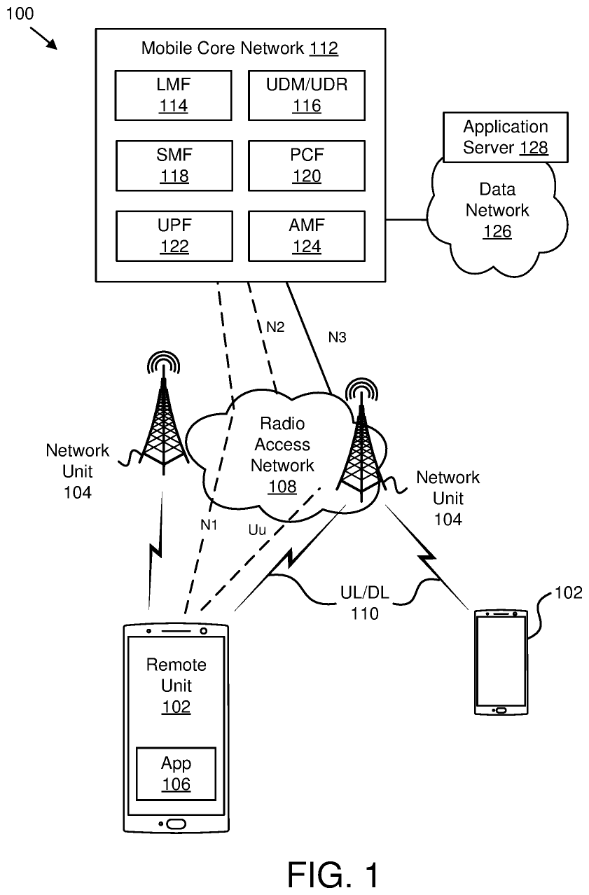

FIG. 1 depicts an embodiment of a wireless communication system 100 for enhancing location estimate accuracy. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication. The remote units 102 may include one or more applications 106.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art. The network units 104 may be part of a RAN 108. Moreover, the network units 104 may receive UL transmission and transmit DL transmissions 110. The RAN 108 may communicate with a mobile core network 112.

Furthermore, the mobile core network 112 includes a location management function (“LMF”) 114, a UDM/UDR 116, an SMF 118, a PCF 120, a UPF 122, and an AMF 124. The mobile core network 112 may communicate with a data network 126 which may include an application server 128.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may transmit, from a device, known location information of the device to a location server for the location server to determine correction information. The known location information includes location determination information, 3D location information, a height estimate, a velocity estimate, or some combination thereof. In some embodiments, the remote unit 102 and/or the network unit 104 may receive assistance data from the location server for performing reference measurements. In certain embodiments, the remote unit 102 and/or the network unit 104 may receive a request from the location server to perform the reference measurements based on a configured signaling protocol defined by the location server. In various embodiments, the remote unit 102 and/or the network unit 104 may transmit the reference measurements to the location server based on the configured signaling protocol defined by the location server. In some embodiments, the remote unit 102 and/or the network unit 104 may receive the correction information derived from the location server to enhance a location estimate accuracy for UE based positioning. Accordingly, the remote unit 102 and/or the network unit 104 may be used for enhancing location estimate accuracy.

In certain embodiments, a network unit 104 may receive, at a location server, known location information from a device for determining correction information. The known location information includes location determination information, 3D location information, a height estimate, a velocity estimate, or some combination thereof. In some embodiments, the network unit 104 may transmit assistance data to the device for performing reference measurements. In certain embodiments, the network unit 104 may transmit a request to the device to perform the reference measurements based on a configured signaling protocol defined by the location server. In various embodiments, the network unit 104 may receive the reference measurements from the device based on the configured signaling protocol defined by the location server. In some embodiments, the network unit 104 may derive the correction information based on the known location information and the reference measurements. In certain embodiments, the network unit 104 may transmit the correction information to the device to enhance a location estimate accuracy for UE based positioning. Accordingly, the network unit 104 may be used for enhancing location estimate accuracy.

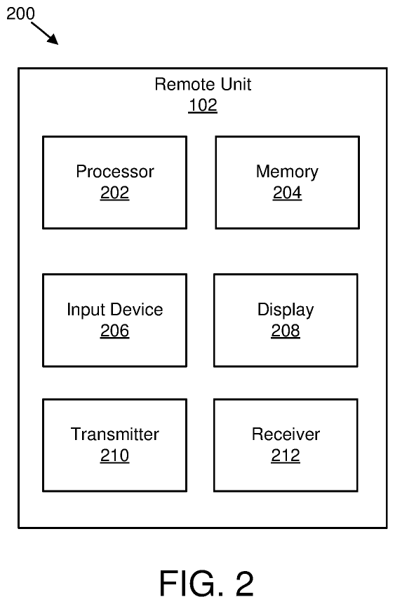

FIG. 2 depicts one embodiment of an apparatus 200 that may be used for enhancing location estimate accuracy. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

In certain embodiments, the transceiver may: transmit known location information of the apparatus to a location server for the location server to determine correction information, wherein the known location information includes location determination information, 3D location information, a height estimate, a velocity estimate, or some combination thereof; receive assistance data from the location server for performing reference measurements; receive a request from the location server to perform the reference measurements based on a configured signaling protocol defined by the location server; transmit the reference measurements to the location server based on the configured signaling protocol defined by the location server; and receive the correction information derived from the location server to enhance a location estimate accuracy for UE based positioning.

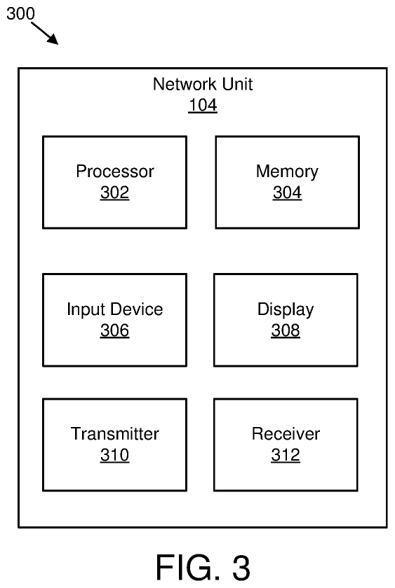

FIG. 3 depicts one embodiment of an apparatus 300 that may be used for enhancing location estimate accuracy. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transceiver may: transmit known location information of the apparatus to a location server for the location server to determine correction information, wherein the known location information includes location determination information, 3D location information, a height estimate, a velocity estimate, or some combination thereof; receive assistance data from the location server for performing reference measurements; receive a request from the location server to perform the reference measurements based on a configured signaling protocol defined by the location server; transmit the reference measurements to the location server based on the configured signaling protocol defined by the location server; and receive the correction information derived from the location server to enhance a location estimate accuracy for UE based positioning.

In some embodiments, the transceiver may: receive known location information from a device for determining correction information, wherein the known location information includes location determination information, 3D location information, a height estimate, a velocity estimate, or some combination thereof; transmit assistance data to the device for performing reference measurements; transmit a request to the device to perform the reference measurements based on a configured signaling protocol defined by the apparatus; and receive the reference measurements from the device based on the configured signaling protocol defined by the apparatus. The processor 302 may derive the correction information based on the known location information and the reference measurements. The transceiver may transmit the correction information to the device to enhance a location estimate accuracy for UE based positioning.

It should be noted that one or more embodiments described herein may be combined into a single embodiment.

In certain embodiments, radio access technology (“RAT”) dependent positioning using new radio (“NR”) technology may be used. Positioning features include fifth generation (“5G”) core network (“5GC”) architectural and interface enhancements, as well as radio access node (“RAN”) functionality that supports NR physical layer and layer-2 and/or layer-3 signaling procedures to enable RAT-dependent and RAT-independent positioning. In some embodiments, NR positioning enhancements may satisfy positioning requirements of industrial internet of things (“IIoT”) scenarios or industrial automation and/or factory floor settings. In various embodiments, there may be a mitigation of user equipment (“UE”) and gNB transmit (“TX”) and/or receive (“RX”) delays to improve the location estimate accuracy.

In some embodiments, there may be enhancements related to configuration and reporting performed by reference devices for: 1) using reference devices with known locations to mitigate UE and transmission and reception point (“TRP”) TX and/or RX delays using differential and/or double differential techniques which extend from the concept of reference stations used in global navigation satellite systems (“GNSS”) to compensate pseudorange errors arising from the timing delays between the GNSS and receiver; and/or 2) considering that reference devices may be fixed and/or mobile for reference UE devices (e.g., an issue may occur in which the reference UE may change locations at a certain given time). A location management function (“LMF”) may not be informed about a change in known location which has to be known precisely to compensate for TX and/or RX timing errors.

In various embodiments, configuration and reporting procedures of a reference device may be enhanced with the following: 1) a method to configure a reference device UE with specific reference measurements as part of assistance data which is different from a normal UE—this includes procedures to configure a reference device in an on-demand manner for providing RAT-dependent reference measurements to a location computing entity (e.g., location server, UE) a reference station and/or base station TRP may be configured to provide reference measurements and correction data including clock errors, atmospheric delays and range errors for RAT-independent positioning methods such as global positioning system (“GPS”) and/or GNSS; 2) a method for dynamically configuring a flag of a normal UE to a reference device UE based on a set of criteria (e.g., if determined to be static after a period of time and/or depending on high precision); 3) a method to enable a reference device and/or reference station to autonomously report its precise location and/or correction data to a LMF using LTE positioning protocol (“LPP”) configured RAT-independent methods from a reference device UE to an LMF; 4) a method for a reference UE trigger location reporting of its known location based on an event (e.g., this may also include delta reporting from a previous known location); 5) a method to provide known location information and measurements of reference device using RRC signaling from a reference device via a gNB to a LMF; 6) a method to enable a reference device to operate in an RRC_INACTIVE state, including new positioning system information blocks (“SIBs”) (“posSIBs”) for reference devices and/or enabling reporting of location in the RRC_INACTIVE state; and/or 7) providing downlink (“DL”) positioning reference signal (“PRS”) (“DL-PRS”) differential correction data for UEs performing UE-based positioning based on DL positioning measurements.

In certain embodiments described herein, there may be: 1) dedicated assistance data for reference devices enabling more flexible configuration between a normal UE and a reference UE; 2) dynamic indication of reference device functionality enabling an existing UE to be configured as a reference device; 3) autonomous reporting of location information enabling efficient signaling for differential corrections: 4) methods that enable reference devices to operate in an RRC_INACTIVE state; 5) methods that enable signaling of differential corrections of positioning measurements to improve a location estimate such as for UE-based positioning methods.

In a first set of embodiments, there may be a configuration of a reference device. Such embodiments describe enhanced procedures and methods to configure a reference device within the 3GPP positioning framework. The reference device enables reference measurements to be provided to the network to use differential methods to correct for pseudo-range as well as other timing-based errors. These reference measurements may include measurements required to enable RAT-dependent positioning methods such as DL-PRS reference signal received power (“RSRP”), reference signal time difference (“RSTD”), and/or UE RX-TX time difference measurements.

A first embodiment of the first set of embodiments may correspond to reference device capabilities. The LMF may configure a specialized UE or a normal (e.g., existing) UE as a reference device to report reference measurements based on its capabilities. In one implementation, the LMF may perform corrections as needed to improve its location estimate or the location estimate computed by the UE. This can happen in one of the following ways: 1) via a capability indication procedure (e.g., using LPP RequestCapabilities) where the reference device provides its reference capabilities via an unsolicited message; 2) via a capability request message (e.g., using LPP RequestCapabilities message), whereby the location server (e.g., LMF) requests the capabilities of the reference device and the UE responds with an indication that it supports reference device functionality including support for reference RAT-dependent or RAT-independent measurements. The response may be transmitted via LPP (e.g., using the LPP ProvideCapabilities message).

In certain embodiments, a reference device may include its own known location information (e.g., if available at the time of capability request) in a capability response message and may include: 1) two-dimensional (“2D”) and/or three-dimensional (“3D”) coordinates including latitude and/or longitude; 2) time information (e.g., including timestamps) and/or time for which the reference location device is valid (e.g., based on a timer); 3) altitude information (e.g., height); 4) precision information such as confidence intervals and/or accuracy; 4) source methods of provided location information (e.g., provide location is derived from assisted GNSS (“A-GNSS”), wireless local area network (“WLAN”), Bluetooth, and so forth; 5) velocity estimates implicitly indicating that the reference device is mobile; 6) orientation information based on an angle of departure (“AoD”) and/or angle of arrival (“AoA”) information; and/or 7) integrity-related information, such as: a) alert limit (“AL”): the maximum allowable positioning error such that the positioning system is available for the intended application—if the positioning error is beyond the AL, operations may be hazardous and the positioning system may be declared unavailable for the intended application to prevent loss of integrity—if the AL bounds the positioning error in a horizontal plane or on a vertical axis then it is called a horizontal alert limit (“HAL”) or vertical alert limit (“VAL”) respectively, b) time to alert (“TTA”): the probability that the positioning error exceeds the AL without warning the user within a required time-to-alert (“TTA”), and c) target integrity risk (“TIR”): the maximum allowable elapsed time from if the positioning error exceeds the AL until the function providing position integrity annunciates a corresponding alert—the TIR is usually defined as a probability rate per some time unit (e.g., per hour, per second, or per independent sample).

In one implementation, the reference device can provide its known location to the LMF via the capability response message based on a set of pre-configured or offline location determination capabilities. In this implementation, it can be further indicated if the location was automatically or manually calibrated.

In another implementation, if the gNB has LMF functionality (e.g., location measurement unit (“LMU”) capabilities) or is co-located with an LMF, the gNB (e.g., serving gNB) may correct the pseud-orange errors and therefore the reference device may report its location and reference measurements to the gNB via radio resource control (“RRC”) or medium access control (“MAC”) control element (“CE”) (“MAC CE”) or layer 1 (“LI”) control signaling. The request for transmitting the positioning information from the reference device may be via RRC and/or MAC CE or LI control signaling and the configuration of positioning report may be aperiodic or semi-persistent from the reference device. A separate MAC CE could enable and/or disable semi-persistent positioning report of the reference device.

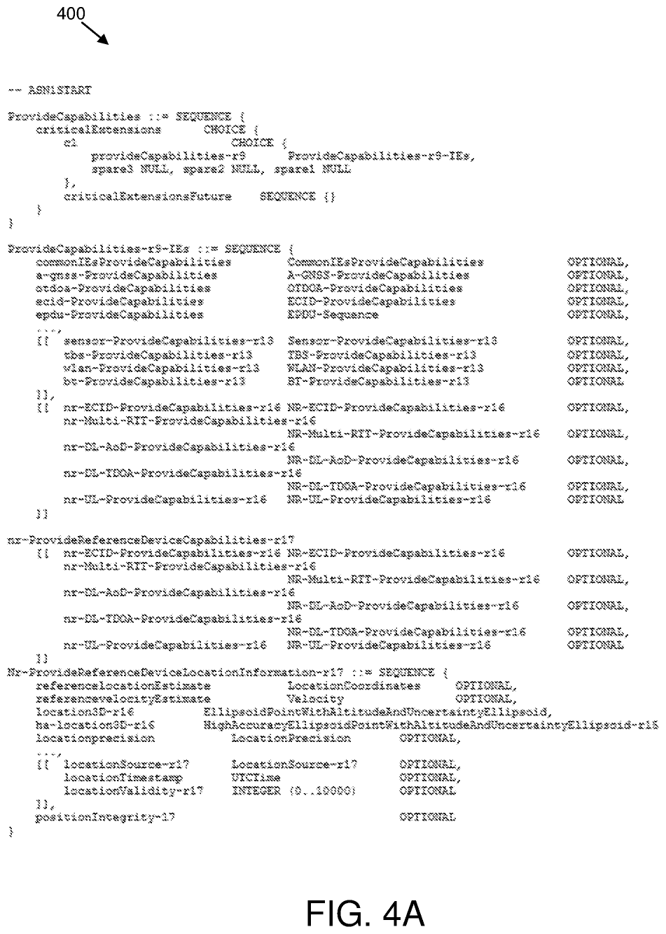

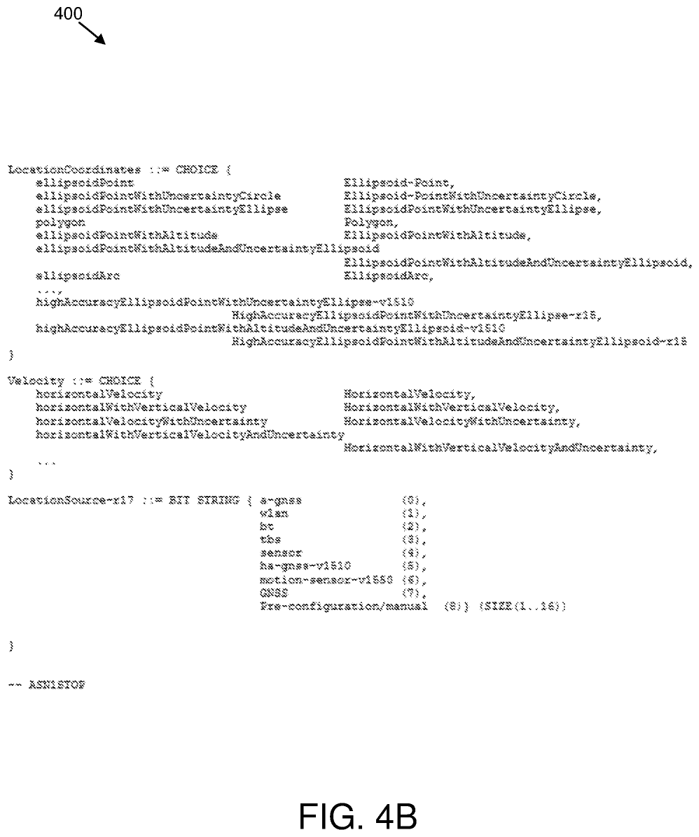

FIGS. 4A and 4B are diagrams illustrating one embodiment of a ProvideCapabilities message 400.

In a second embodiment of the first set of embodiments, there may be scheduling of reference devices. The reference device may be scheduled with the DL-PRS and/or sounding reference signal (“SRS”) for positioning time-frequency resources using: 1) a dedicated message (e.g., using LPP ProvideAssistanceData) where separate assistance data for reference device measurements may be configured with a transmission to the UE in relation to DL-PRS measurements: 2) RRC configuration signaling for SRS for positioning (“SRS-Pos”) resources using an SRS-config IE; and/or 3) via broadcast signaling to multiple reference devices in a given area.

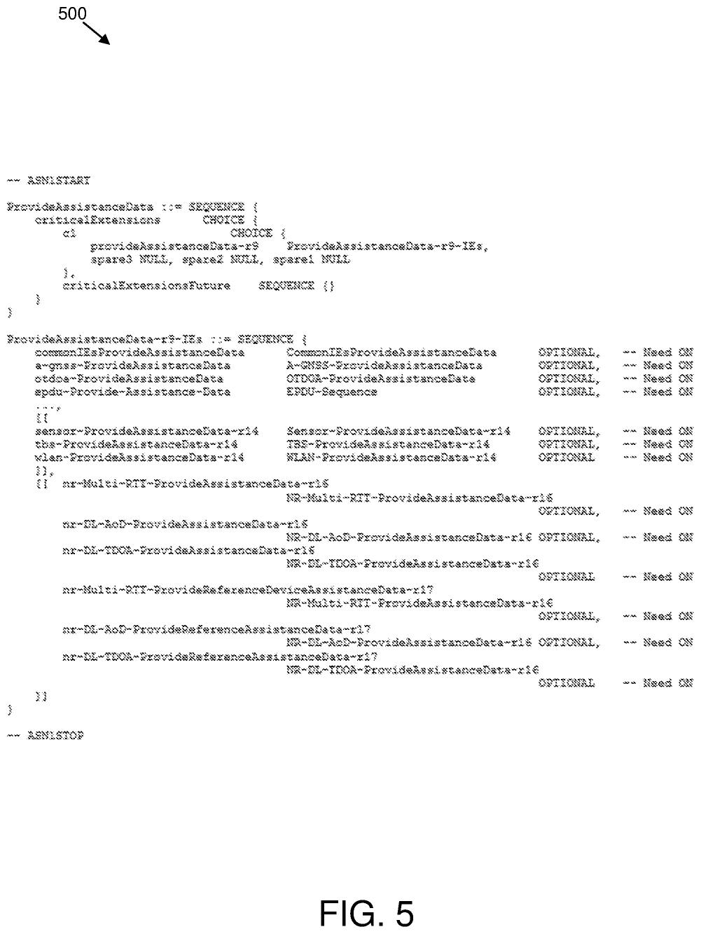

FIG. 5 is a diagram illustrating one embodiment of a ProvideAssistance Data message 500.

In one implementation, the assistance data for a normal UE may apply to a reference UE provided that there are no reference device-specific changes to the DL-PRS resources. Separate assistance data for the reference device UE may allow for freedom of configurability of the reference device.

Additionally, in some implementations, an LMF can initiate on-demand DL-PRS resources for reference devices based on the LMF-initiated procedures for on-demand DL-PRS. This may include on-demand provided assistance data procedures to dynamically update the UE. The LMF may enable triggering of a normal UE as a reference device or conversely disable a reference device functionality of a normal UE via the on-demand DL-PRS procedure.

In various implementations, the LMF may provide assistance data to a UE conditioned on an enable and/or disable flag functionality of a reference device in a normal UE.

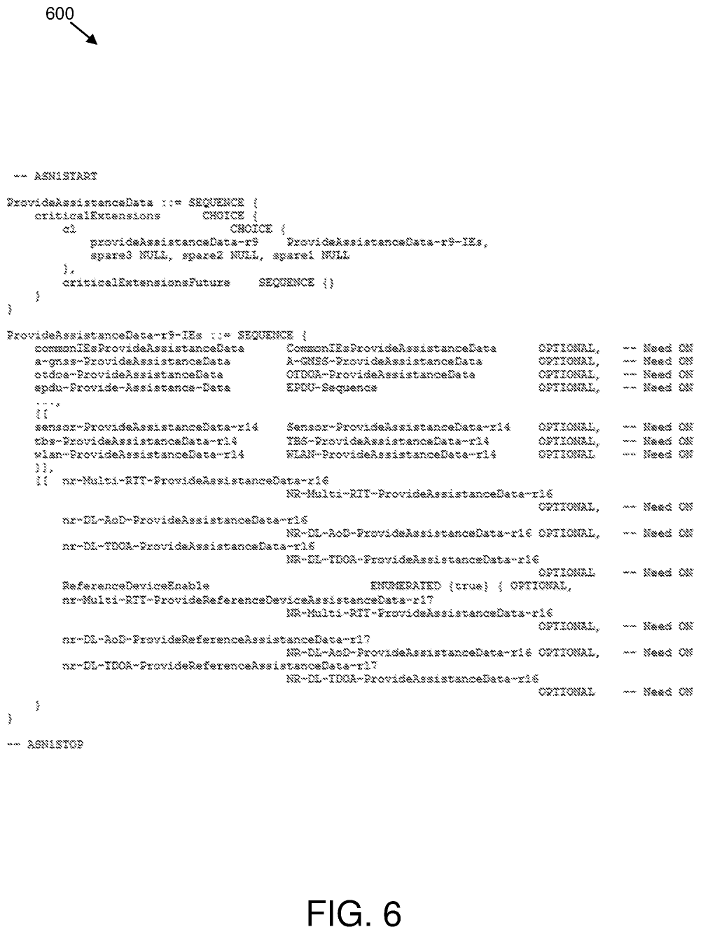

FIG. 6 is a diagram illustrating another embodiment of a ProvideAssistanceData message 600.

In certain implementations, a flag Reference DeviceEnable may be present to enable and/or disable reference device functionality without conditional provisioning assistance data.

In a second set of embodiments, autonomous reporting of an updated location of a reference device may be enabled. The second set of embodiments enable mechanisms for the reference device to autonomously provide its updated location information report based on a set of events in an unsolicited manner. One such criteria includes any change in the reference device location based on certain threshold criteria. For example, if the reference device UE has detected any change (e.g., delta, A) in location information corresponding to a: 1) delta of 2D and/or 3D latitude and longitude coordinates when compared to the previous 2D and/or 3D location, which may exceed a certain distance, range, and/or boundary; 2) delta orientation compared to the previous orientation of the reference device; 3) delta velocity change compared to a previous reported value of the reference device; 4) delta height compared to a previous reported height of the reference device; and/or 5) time elapsed from a previous known location report that exceeds a threshold.

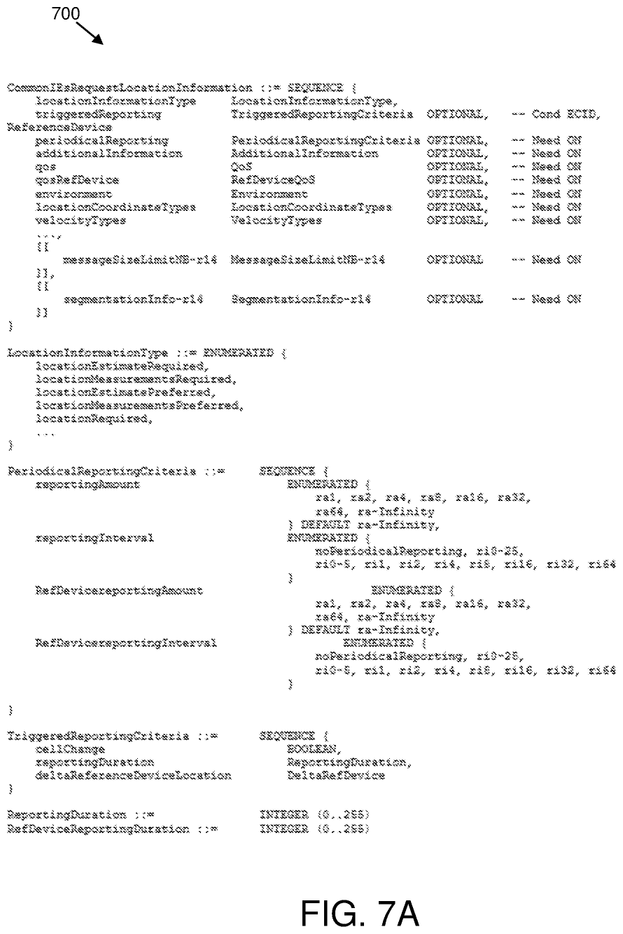

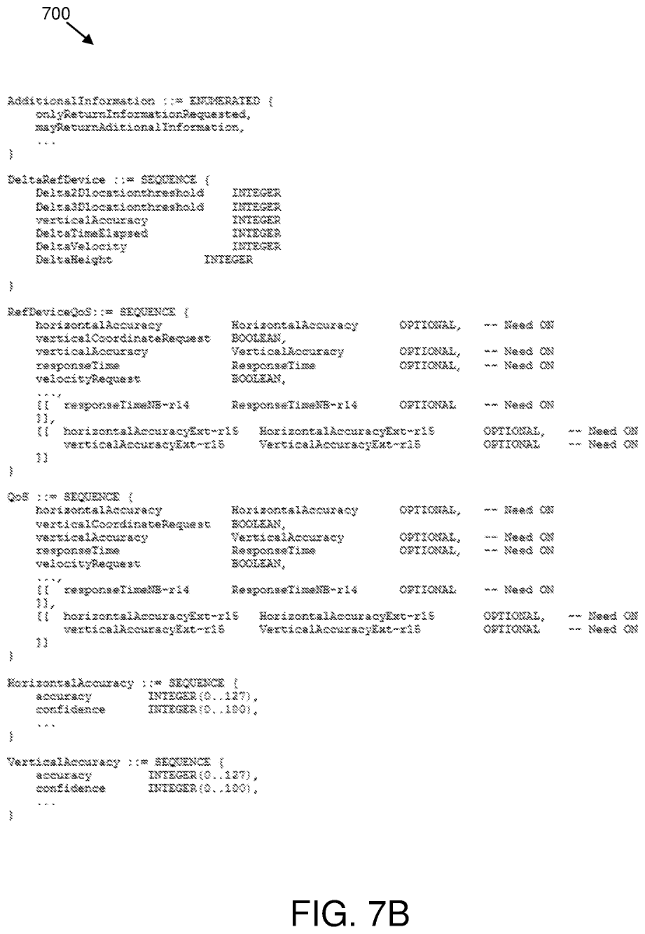

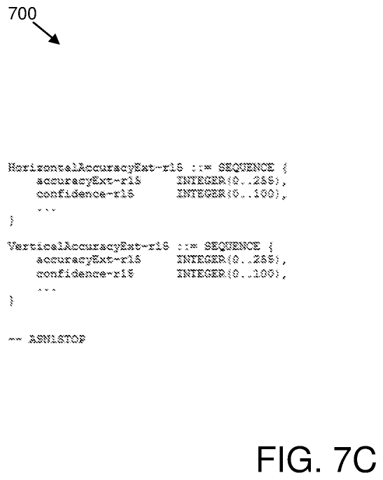

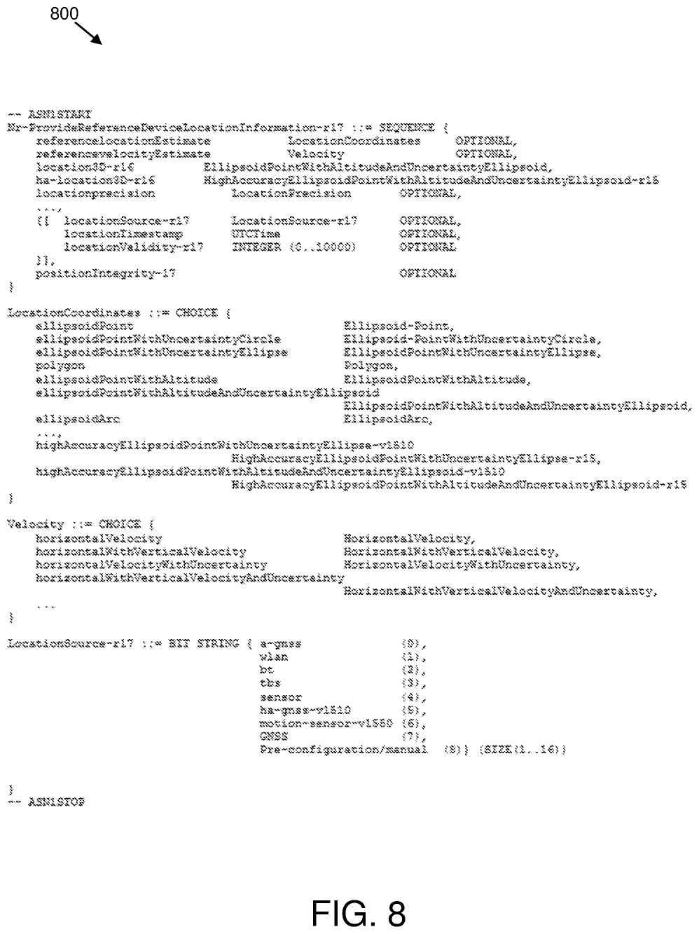

FIGS. 7A, 7B, and 7C are diagrams illustrating one embodiment of a RequestLocationInformation message 700. Further, FIG. 8 is a diagram illustrating one embodiment of a ProvideLocationInformation message 800.

In certain implementations, the reference device may provide it location information via assistance data signaling (e.g., using LPP RequestAssistanceData). For UE-based positioning, a UE may be configured as a reference device UE.

In a third set of embodiments, reporting of a known reference device location may be enabled via RRC. To exploit degrees of freedom of a reference device to provide its known location information to an LMF, a reference device may provide such location information via RRC signaling.

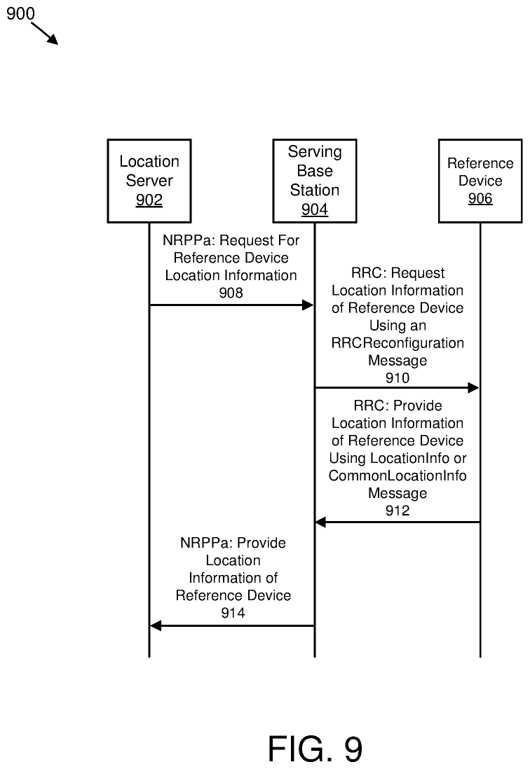

FIG. 9 is a schematic block diagram illustrating one embodiment of a system 900 including a location information transfer procedure using NR positioning protocol annex (“NRPPa”) and RRC signaling. The system 900 includes a location server 902, a serving base station 904, and a reference device 906 (e.g., UE). Each of the communications in the system 900 include one or more messages. In a first communication 908, the location server 902 transmits a request for reference device location information (e.g., via NRPPa signaling) to the serving base station 904. In a second communication 910, the serving base station 904 transmits a request for location information of the reference device 906 using an RRCReconfiguration message (e.g., via RRC signaling) to the reference device 906. In a third communication 912, the reference device 906 provides location information of the reference device 906 using a LocationInfo or a CommonLocationInfo message (e.g., via RRC signaling) to the serving base station 904. In a fourth communication 914, the serving base station 904 provides location information of the reference device 906 (e.g., via NRPPa) to the location server 902.

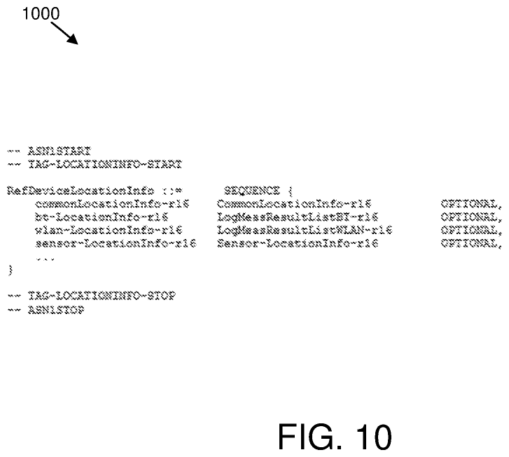

In one implementation, a reference device aware of its capability can provide an unsolicited message to a serving gNB (e.g., skipping step 910 of FIG. 9). FIG. 10 is a diagram illustrating one embodiment of a RefDeviceLocationInfo message 1000.

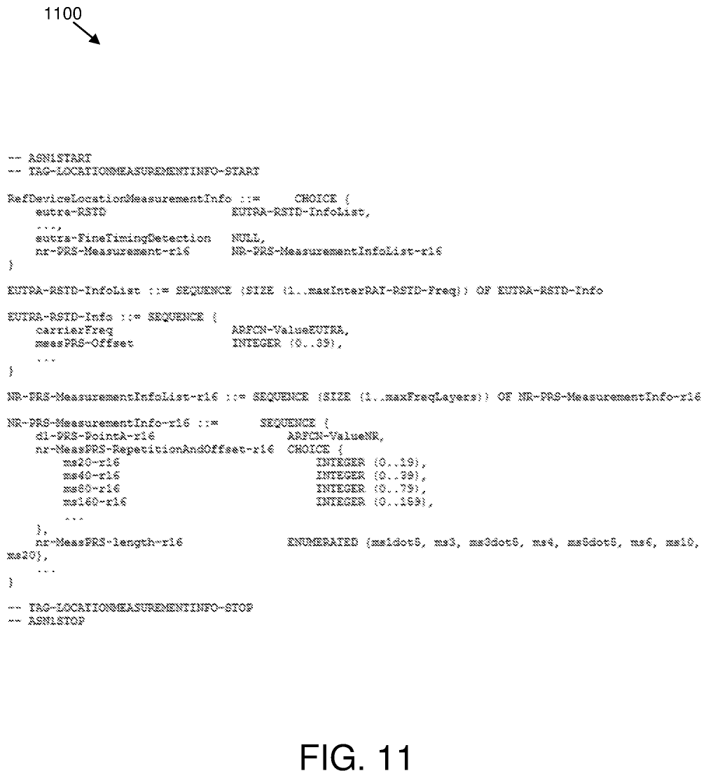

In a fourth set of embodiments, reporting of a reference device measurements may be enabled via RRC. Similar to the third set of embodiments, the reference device can be configured to report its measurement via RRC. This is done to exploit the degrees of freedom of a reference device to provide its measurement information to the LMF and is shown in FIG. 11. Specifically, FIG. 11 is a diagram illustrating one embodiment of a RefDevice Location MeasurementInfo message 1100.

In one implementation, if the gNB has LMF functionality (e.g., LMU capabilities) or is co-located with an LMF, the gNB (e.g., serving gNB) may correct the pseudo-range errors and therefore the reference device may report its location and reference measurements to the gNB via RRC or MAC CE signaling.

In a fifth set of embodiments, reference device functionality may be enabled in RRC_IDLE and/or RRC_INACTIVE states. Such embodiments describe a feature enabling the reference device to be configured with reference measurements and report its location estimate in an RRC_INACTIVE state.

In a first embodiment of the fifth set of embodiments, there may be system information for reference devices. Depending on a number of UEs in a given area, the DL-PRS resources for measurement by reference devices may need to be broadcasted for efficient signaling of the assistance information. As such, the positioning system information blocks (“posSIBs”) may need to make an association and distinction between which assistance data is applicable for reference devices and normal performing positioning procedures. This is shown in Table Table 1 where new posSIB is shown for reference device UEs, which is applicable to UEs operating in RRC_IDLE, RRC_INACTIVE, and RRC_CONNECTED states.

TABLE 1
New posSIBs for Reference Device

| | | |
|---|---|---|
| NR DL-TDOA/ | posSibType6-1 | NR-DL-PRS-AssistanceData |
| DL-AoD | posSibType6-2 | NR-UEB-TRP-LocationData |
| Assistance | posSibType6-3 | NR-UEB-TRP-RTD-Info |
| Data (DL-only | posSibType6-4 | NR-DL-PRS-RefDeviceAssistanceData |
| measurements) | posSibType6-5 | NR-UEB-DL-PRS- |
| | | DifferentialCorrections |

In certain implementations, the DL-PRS resources to be measured by a reference device may be included in a posSIBType6-1 if the positioning measurements such as DL-PRS, RSTD, and/or UE RX-TX difference measurements for normal UE overlap with a reference device.

In the case of UE-based positioning, a location server (e.g., LMF) may have already compensated for the differential corrections in the timing delay of DL-based positioning methods and may directly provide the differential corrections via posSIBType6-5 dedicated to differential error correction of the DL-PRS measurements.

In various implementation, differential corrections related to the DL-PRS measurements already computed at the location server may already be provided in either posSIBType6-1 or posSIBType6-4, if available at the time of provision of the assistance data. Furthermore, the differential corrections based prior assistance from a reference device may be applicable to timing-based and/or angular-based positioning methods.

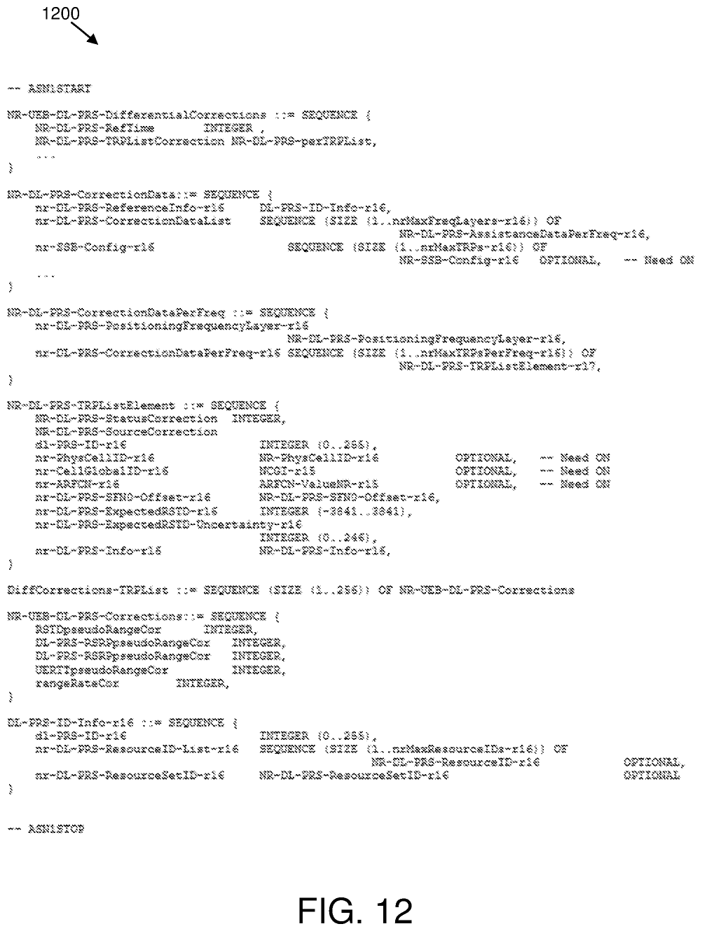

FIG. 12 is a diagram illustrating one embodiment of a NR-UEB-DL-PRS-DifferentialCorrections message 1200 for UE-based positioning. Table 2 shows NR-UEB-DL-PRS-DifferentialCorrections field descriptions.

TABLE 2
NR-UEB-DL-PRS-DifferentialCorrections Field Descriptions

NR-DL-PRS-RefTime
This field specifies the time for which the NR-DL-PRS corrections are valid, modulo 1 hour. NR-
DL-PRS-RefTime can be given in a specific system time system, e.g. UTC.
Scale factor 1-second.
NR-DL-PRS-TRPListCorrection
This list includes differential correction data for different TRPs corrsponding to different
positioning frequency layers.
NR-DL-PRS-StatusCorrection
This field specifies the status of the differential corrections for the DL-PRS measurements.
This field indicates the validity of NR DL-PRS differential corrections. The purpose is to indicate
an estimate in the amount of error in the corrections.
NR-DL-PRS-SourceCorrection
This value indicates that the source of the differential corrections (e.g., reference device type)
RSTDpseudoRangeCor
This field specifies the correction to the pseudorange error for the different RSTD measurements
between TRPs
DL-PRS-RSRPpseudoRangeCor
This field specifies the correction to the pseudorange error for the RSRP measurements.
UERTTpseudoRangeCor
This field specifies the correction to the pseudorange error for the round trip time (“RTT”)
measurements (e.g. UE Rx-Tx difference measurements).
range RateCor
This field specifies the rate-of-change of the pseudorange correction for a type of pseudorange
error (e.g RSTDpseudoRangeCor)

In a second embodiment of the fifth set of embodiments, there may be location and reference measurement reporting for reference devices in an RRC_INACTIVE state. This embodiment describes a method that enables a reference device to report its known location and reference measurements in the RRC_INACTIVE state. The LMF may request the reference device to provide the location estimate and/or reference measurement in the RRC_INACTIVE state via request signaling (e.g., LPP RequestLocationInformation). The request may also include updates to previously known locations. This request may be provided in an RRC_CONNECTED state before transitioning to RRC_INACTIVE state or in other implementations the request signaling may be received broadcast signaling while in the RRC_INACTIVE state.

In one implementation, the reference device may autonomously report its known location information as described in the first set of embodiments in the RRC_INACTIVE state using signaling (e.g., LPP ProvideLocationInformation message based on the triggers and procedures described in the third set of embodiments). An exemplary trigger may include delta location information exceeding a certain threshold value which will initiate an updated location information report.

In a sixth set of embodiments, there may be a line of sight (“LOS”) and/or non LOS (“NLOS”) configuration of measurements for normal UEs and reference device UEs. Such embodiments describe a mechanism whereby a normal UE performing positioning or a reference device performing reference measurements for range and/or timing error correction can be configured to measure the same resources required positioning using a set of RX beams. The location server (e.g., LMF may configure a set of DL-PRS resources and/or resource set as assistance data to be measured over a configured set of RX beam at the UE-side). This is to enhance the degrees of freedom in terms of added information about a specific DL-PRS measurement. The LMF may use such information to draw a better understanding of the DL-AoD and/or AoA of the beam transmitting DL-PRS. The same DL-PRS resource measured across a set of N RX beams may be fixed in the specification through a configuration associating the DL-PRS resources (e.g., DL-PRS resource ID to be measured with N Rx beams at the UE-side). This configuration can be signaled using dedicated signaling to the UE (e.g., LPP PovideAssistanceData or via positioning system information broadcast signaling to multiple UEs).

In various implementations, the reference device may aid in mitigating multipath and/or NLOS effects, which can reduce the overall positioning accuracy. The reference device would be in the proximity of the normal UEs performing positioning and exhibit the similar receive radio characteristics in terms of NLOS amplitude and phase and, therefore, such multipath and/or NLOS characteristics can be derived from the reference device itself. The reference device can then signal via LPP to the LMF the multipath and/or NLOS characteristics of a given area in the form of binary indicators or soft decision metrics indicating the LOS and/or NLOS characteristics of the signal.

In certain implementations, the UE may also add additional information to the specific DL-PRS resource measurement (e.g., related to the timestamp of the measurement), binary or soft indicator values regarding the LOS and/or NLOS state of the measurement based on a time window configuration in which UE measures the specific DL-PRS resource across the set of N beams.

In some embodiments, a reference station may provide correction data of GPS and/or GNSS to the LMF in an on-demand manner which could be scheduled at any given time based on, for example, an event-trigger. It should be noted that embodiments described herein may apply to a reference station or base station with TRPs.

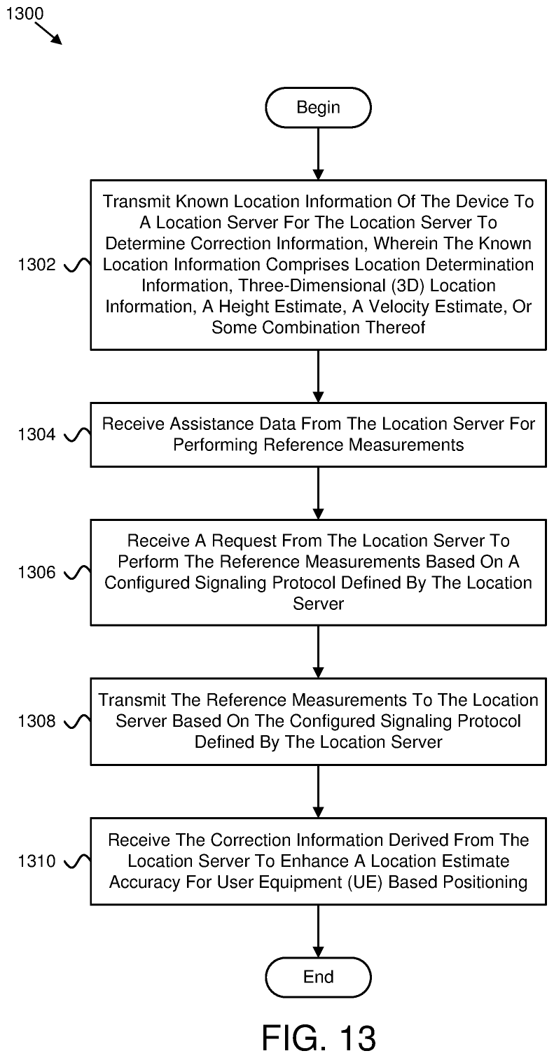

FIG. 13 is a flow chart diagram illustrating one embodiment of a method 1300 for enhancing location estimate accuracy. In some embodiments, the method 1300 is performed by an apparatus, such as the remote unit 102 and/or the network unit 104. In certain embodiments, the method 1300 may be performed by a processor executing program code, for example, a microcontroller, a microprocessor, a CPU, a GPU, an auxiliary processing unit, a FPGA, or the like.

In various embodiments, the method 1300 includes transmitting 1302, from a device, known location information of the device to a location server for the location server to determine correction information. The known location information includes location determination information, 3D location information, a height estimate, a velocity estimate, or some combination thereof. In some embodiments, the method 1300 includes receiving 1304 assistance data from the location server for performing reference measurements. In certain embodiments, the method 1300 includes receiving 1306 a request from the location server to perform the reference measurements based on a configured signaling protocol defined by the location server. In various embodiments, the method 1300 includes transmitting 1308 the reference measurements to the location server based on the configured signaling protocol defined by the location server. In some embodiments, the method 1300 includes receiving 1310 the correction information derived from the location server to enhance a location estimate accuracy for UE based positioning.

In certain embodiments, the known location information transmitted comprises 2D coordinates, 3D coordinates, time information related to validity of a known location, altitude information, precision information, source methods corresponding to the known location information, integrity information, or some combination thereof. In some embodiments, the known location information is: provided in a solicited manner using NRPPa and RRC request and response signaling: provided in the solicited manner using LPP request and response signaling; provided in the solicited manner using LPP providing capability signaling; or provided in the solicited manner using LPP providing location information signaling. In various embodiments, the known location information comprises pre-configured or offline calibration, input, or a combination thereof.

In one embodiment, the method 1300 further comprises enabling reference device functionality using LPP signaling, RRC signaling, or a combination thereof. In certain embodiments, the method 1300 further comprises receiving an event-triggered criteria via an LPP configuration or an RRC configuration to enable autonomous transmission of location information elements by a reference device. In some embodiments, the method 1300 further comprises transmitting updated location information elements based on changes with respect to previously reported location information elements.

In various embodiments, the method 1300 further comprises transmitting a validity time of a reported location. In one embodiment, the correction information is applicable to DL-TDOA, DL-AOD, Multi-RTT, or some combination thereof. In certain embodiments, the correction information comprises a validity time for which DL-PRS corrections are valid, RTT timing correction information, RSTD timing correction information between a pair of TRPs, positioning reference device source information, or some combination thereof.

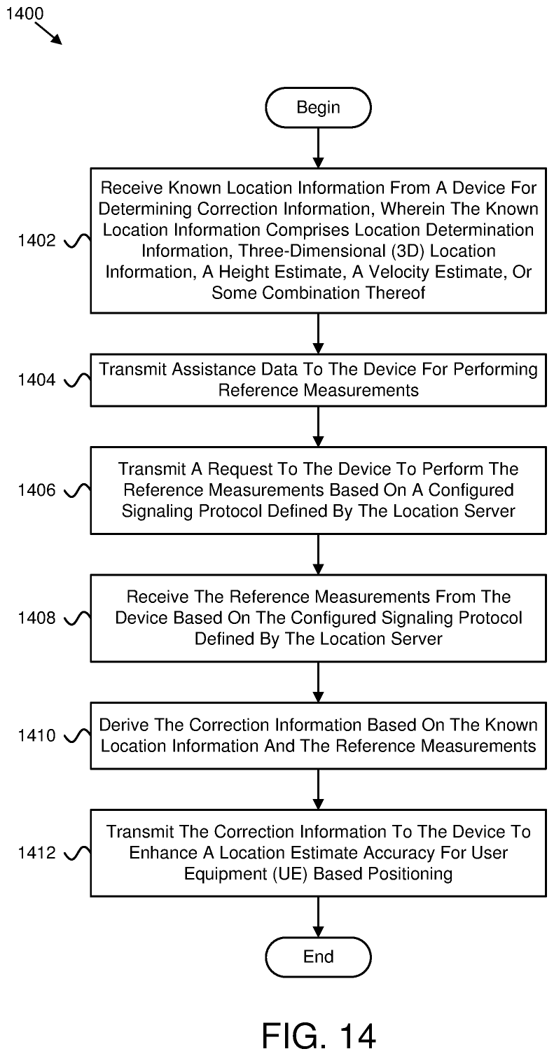

FIG. 14 is a flow chart diagram illustrating another embodiment of a method 1400 for enhancing location estimate accuracy. In some embodiments, the method 1400 is performed by an apparatus, such as the network unit 104 (e.g., location server). In certain embodiments, the method 1400 may be performed by a processor executing program code, for example, a microcontroller, a microprocessor, a CPU, a GPU, an auxiliary processing unit, a FPGA, or the like.

In various embodiments, the method 1400 includes receiving 1402 known location information from a device for determining correction information. The known location information includes location determination information, 3D location information, a height estimate, a velocity estimate, or some combination thereof. In some embodiments, the method 1400 includes transmitting 1404 assistance data to the device for performing reference measurements. In certain embodiments, the method 1400 includes transmitting 1406 a request to the device to perform the reference measurements based on a configured signaling protocol defined by the location server. In various embodiments, the method 1400 includes receiving 1408 the reference measurements from the device based on the configured signaling protocol defined by the location server. In some embodiments, the method 1400 includes deriving 1410 the correction information based on the known location information and the reference measurements. In certain embodiments, the method 1400 includes transmitting 1412 the correction information to the device to enhance a location estimate accuracy for UE based positioning.

In certain embodiments, the known location information comprises 2D coordinates, 3D coordinates, time information related to validity of a known location, altitude information, precision information, source methods corresponding to the known location information, integrity information, or some combination thereof. In some embodiments, the known location information is: received in a solicited manner using NRPPa and RRC request and response signaling; received in the solicited manner using LPP request and response signaling; received in the solicited manner using LPP providing capability signaling; or received in the solicited manner using LPP providing location information signaling. In various embodiments, the known location information comprises pre-configured or offline calibration, input, or a combination thereof.

In one embodiment, the method 1400 further comprises transmitting an event-triggered criteria via an LPP configuration or an RRC configuration to enable autonomous transmission of location information elements by a reference device. In certain embodiments, the method 1400 further comprises receiving updated location information elements based on changes with respect to previously reported location information elements. In some embodiments, the method 1400 further comprises receiving a validity time of a reported location.

In various embodiments, the correction information is applicable to DL-TDOA, DL-AOD, Multi-RTT, or some combination thereof. In one embodiment, the correction information comprises a validity time for which DL-PRS corrections are valid, RTT timing correction information, RSTD timing correction information between a pair of TRPs, positioning reference device source information, or some combination thereof.

In one embodiment, an apparatus comprises a transceiver to: transmit known location information of the apparatus to a location server for the location server to determine correction information, wherein the known location information comprises location determination information, 3D location information, a height estimate, a velocity estimate, or some combination thereof; receive assistance data from the location server for performing reference measurements; receive a request from the location server to perform the reference measurements based on a configured signaling protocol defined by the location server; transmit the reference measurements to the location server based on the configured signaling protocol defined by the location server; and receive the correction information derived from the location server to enhance a location estimate accuracy for UE based positioning.

In certain embodiments, the known location information transmitted comprises 2D coordinates, 3D coordinates, time information related to validity of a known location, altitude information, precision information, source methods corresponding to the known location information, integrity information, or some combination thereof.

In some embodiments, the known location information is: provided in a solicited manner using NRPPa and RRC request and response signaling; provided in the solicited manner using LPP request and response signaling; provided in the solicited manner using LPP providing capability signaling; or provided in the solicited manner using LPP providing location information signaling.

In various embodiments, the known location information comprises pre-configured or offline calibration, input, or a combination thereof.

In one embodiment, the apparatus further comprises a processor to enable reference device functionality using LPP signaling, RRC signaling, or a combination thereof.

In certain embodiments, the transceiver further to receive an event-triggered criteria via an LPP configuration or an RRC configuration to enable autonomous transmission of location information elements by a reference device.

In some embodiments, the transceiver further to transmit updated location information elements based on changes with respect to previously reported location information elements.

In various embodiments, the transceiver further to transmit a validity time of a reported location.

In one embodiment, the correction information is applicable to DL-TDOA, DL-AOD, Multi-RTT, or some combination thereof.

In certain embodiments, the correction information comprises a validity time for which DL-PRS corrections are valid, RTT timing correction information, RSTD timing correction information between a pair of TRPs, positioning reference device source information, or some combination thereof.

In one embodiment, a method in a device comprises: transmitting known location information of the device to a location server for the location server to determine correction information, wherein the known location information comprises location determination information, 3D location information, a height estimate, a velocity estimate, or some combination thereof; receiving assistance data from the location server for performing reference measurements; receiving a request from the location server to perform the reference measurements based on a configured signaling protocol defined by the location server; transmitting the reference measurements to the location server based on the configured signaling protocol defined by the location server; and receiving the correction information derived from the location server to enhance a location estimate accuracy for UE based positioning.

In certain embodiments, the known location information transmitted comprises 2D coordinates, 3D coordinates, time information related to validity of a known location, altitude information, precision information, source methods corresponding to the known location information, integrity information, or some combination thereof.

In some embodiments, the known location information is: provided in a solicited manner using NRPPa and RRC request and response signaling; provided in the solicited manner using LPP request and response signaling; provided in the solicited manner using LPP providing capability signaling; or provided in the solicited manner using LPP providing location information signaling.

In various embodiments, the known location information comprises pre-configured or offline calibration, input, or a combination thereof.

In some embodiments, the transceiver adds additional information to a specific DL-PRS resource measurement, wherein the additional information comprises binary or soft indicator values regarding a LOS or NLOS state of the specific DL-PRS resource measurement.

In one embodiment, the method further comprises enabling reference device functionality using LPP signaling, RRC signaling, or a combination thereof.

In certain embodiments, the method further comprises receiving an event-triggered criteria via an LPP configuration or an RRC configuration to enable autonomous transmission of location information elements by a reference device.

In some embodiments, the method further comprises transmitting updated location information elements based on changes with respect to previously reported location information elements.

In various embodiments, the method further comprises transmitting a validity time of a reported location.

In one embodiment, the correction information is applicable to DL-TDOA, DL-AOD, Multi-RTT, or some combination thereof.

In certain embodiments, the correction information comprises a validity time for which DL-PRS corrections are valid, RTT timing correction information, RSTD timing correction information between a pair of TRPs, positioning reference device source information, or some combination thereof.

In one embodiment, an apparatus comprises: a transceiver; and a processor coupled to the transceiver, wherein: the transceiver to: receive known location information from a device for determining correction information, wherein the known location information comprises location determination information, 3D location information, a height estimate, a velocity estimate, or some combination thereof; transmit assistance data to the device for performing reference measurements; transmit a request to the device to perform the reference measurements based on a configured signaling protocol defined by the apparatus; and receive the reference measurements from the device based on the configured signaling protocol defined by the apparatus; the processor to derive the correction information based on the known location information and the reference measurements; and the transceiver to transmit the correction information to the device to enhance a location estimate accuracy for UE based positioning.

In certain embodiments, the known location information comprises 2D coordinates, 3D coordinates, time information related to validity of a known location, altitude information, precision information, source methods corresponding to the known location information, integrity information, or some combination thereof.

In some embodiments, the known location information is: received in a solicited manner using NRPPa and RRC request and response signaling; received in the solicited manner using LPP request and response signaling; received in the solicited manner using LPP providing capability signaling; or received in the solicited manner using LPP providing location information signaling.

In various embodiments, the known location information comprises pre-configured or offline calibration, input, or a combination thereof.

In one embodiment, the transceiver further to transmit an event-triggered criteria via an LPP configuration or an RRC configuration to enable autonomous transmission of location information elements by a reference device.

In certain embodiments, the transceiver further to receive updated location information elements based on changes with respect to previously reported location information elements.

In some embodiments, the transceiver further to receive a validity time of a reported location.

In various embodiments, the correction information is applicable to DL-TDOA, DL-AOD, Multi-RTT, or some combination thereof.

In one embodiment, the correction information comprises a validity time for which DL-PRS corrections are valid, RTT timing correction information, RSTD timing correction information between a pair of TRPs, positioning reference device source information, or some combination thereof.

In one embodiment, a method in a location server comprises: receiving known location information from a device for determining correction information, wherein the known location information comprises location determination information, 3D location information, a height estimate, a velocity estimate, or some combination thereof; transmitting assistance data to the device for performing reference measurements; transmitting a request to the device to perform the reference measurements based on a configured signaling protocol defined by the location server; receiving the reference measurements from the device based on the configured signaling protocol defined by the location server; deriving the correction information based on the known location information and the reference measurements; and transmitting the correction information to the device to enhance a location estimate accuracy for UE based positioning.

In certain embodiments, the known location information comprises 2D coordinates, 3D coordinates, time information related to validity of a known location, altitude information, precision information, source methods corresponding to the known location information, integrity information, or some combination thereof.

In some embodiments, the known location information is: received in a solicited manner using NRPPa and RRC request and response signaling; received in the solicited manner using LPP request and response signaling; received in the solicited manner using LPP providing capability signaling; or received in the solicited manner using LPP providing location information signaling.

In various embodiments, the known location information comprises pre-configured or offline calibration, input, or a combination thereof.

In one embodiment, the method further comprises transmitting an event-triggered criteria via an LPP configuration or an RRC configuration to enable autonomous transmission of location information elements by a reference device.

In certain embodiments, the method further comprises receiving updated location information elements based on changes with respect to previously reported location information elements.

In some embodiments, the method further comprises receiving a validity time of a reported location.

In various embodiments, the correction information is applicable to DL-TDOA, DL-AOD, Multi-RTT, or some combination thereof.

In one embodiment, the correction information comprises a validity time for which DL-PRS corrections are valid, RTT timing correction information, RSTD timing correction information between a pair of TRPs, positioning reference device source information, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
transmit known location information of the UE to a location server for the location server to determine correction information, wherein the known location information comprises location determination information, three-dimensional (3D) location information, a height estimate, a velocity estimate, or some a combination thereof;
receive assistance data from the location server for performing reference measurements;
receive a request from the location server to perform the reference measurements based on a configured signaling protocol defined by the location server;
transmit the reference measurements to the location server based on the configured signaling protocol defined by the location server; and
receive the correction information derived from the location server to enhance a location estimate accuracy for (UE) based positioning.

2. The UE of claim 1, wherein the known location information transmitted comprises two dimensional (2D) coordinates, 3D coordinates, time information related to validity of a known location, altitude information, precision information, source methods corresponding to the known location information, integrity information, or a combination thereof.

3. The UE of claim 1, wherein the known location information is:
provided in a solicited manner using new radio positioning protocol annex (NRPPa) and radio resource control (RRC) request and response signaling;
provided in the solicited manner using long term evolution (LTE) positioning protocol (LPP) request and response signaling;
provided in the solicited manner using LPP providing capability signaling; or
provided in the solicited manner using LPP providing location information signaling.

4. The UE of claim 1, wherein the known location information comprises pre-configured or offline calibration, input, or a combination thereof.

5. The UE of claim 1, wherein the at least one processor is configured to cause the UE to add additional information to a specific DL-PRS resource measurement, wherein the additional information comprises binary or soft indicator values regarding a line-of-sight (LOS) or non-LOS (NLOS) state of the specific DL-PRS resource measurement.

6. The UE of claim 1, wherein the at least one processor is configured to cause the UE to receive an event-triggered criteria via an LPP configuration or an RRC configuration to enable autonomous transmission of location information elements by a reference device.

7. The UE of claim 1, wherein the at least one processor is configured to cause the UE to transmit updated location information elements based on changes with respect to previously reported location information elements.

8. The UE of claim 1, wherein the at least one processor is configured to cause the UE to transmit a validity time of a reported location.

9. The UE of claim 1, wherein the correction information is applicable to downlink (DL) time difference of arrival (TDOA) (DL-TDOA), DL angle of departure (AOD) (DL-AOD), multiple round trip time (RTT) (Multi-RTT), or some a combination thereof.

10. The UE of claim 9, wherein the correction information comprises a validity time for which DL positioning reference signals (PRS) (DL-PRS) corrections are valid, RTT timing correction information, reference signal time difference (RSTD) timing correction information between a pair of transmission and reception points (TRPs), positioning reference device source information, or a combination thereof.

11. A method performed by a user equipment (UE), the method comprising:
transmitting known location information of the UE to a location server for the location server to determine correction information, wherein the known location information comprises location determination information, three-dimensional (3D) location information, a height estimate, a velocity estimate, or a combination thereof;
receiving assistance data from the location server for performing reference measurements;
receiving a request from the location server to perform the reference measurements based on a configured signaling protocol defined by the location server;
transmitting the reference measurements to the location server based on the configured signaling protocol defined by the location server; and
receiving the correction information derived from the location server to enhance a location estimate accuracy for user equipment (UE) based positioning.

12. An apparatus for performing a network function, the apparatus comprising:
at least one memory; and
at least one processor coupled with the at least one memory and configured to cause the apparatus to:
receive known location information from a device for determining correction information, wherein the known location information comprises location determination information, three-dimensional (3D) location information, a height estimate, a velocity estimate, or some a combination thereof;
transmit assistance data to the device for performing reference measurements;
transmit a request to the device to perform the reference measurements based on a configured signaling protocol defined by the apparatus;
receive the reference measurements from the device based on the configured signaling protocol defined by the apparatus;
derive the correction information based on the known location information and the reference measurements; and
transmit the correction information to the device to enhance a location estimate accuracy for user equipment (UE) based positioning.

13. The apparatus of claim 12, wherein the known location information comprises two dimensional (2D) coordinates, 3D coordinates, time information related to validity of a known location, altitude information, precision information, source methods corresponding to the known location information, integrity information, or a combination thereof.

14. The apparatus of claim 12, wherein the known location information is:
received in a solicited manner using new radio positioning protocol annex (NRPPa) and radio resource control (RRC) request and response signaling;
received in the solicited manner using long term evolution (LTE) positioning protocol (LPP) request and response signaling;
received in the solicited manner using LPP providing capability signaling; or
received in the solicited manner using LPP providing location information signaling.

15. The apparatus of claim 12, wherein the at least one processor is configured to cause the apparatus to receive updated location information elements based on changes with respect to previously reported location information elements.

16. A processor for wireless communication, comprising:
at least one controller coupled with at least one memory and configured to cause the processor to:
transmit known location information of the processor to a location server for the location server to determine correction information, wherein the known location information comprises location determination information, three-dimensional (3D) location information, a height estimate, a velocity estimate, or a combination thereof;
receive assistance data from the location server for performing reference measurements;
receive a request from the location server to perform the reference measurements based on a configured signaling protocol defined by the location server;
transmit the reference measurements to the location server based on the configured signaling protocol defined by the location server; and
receive the correction information derived from the location server to enhance a location estimate accuracy for user equipment (UE) based positioning.

17. The processor of claim 16, wherein the known location information transmitted comprises two dimensional (2D) coordinates, 3D coordinates, time information related to validity of a known location, altitude information, precision information, source methods corresponding to the known location information, integrity information, or some a combination thereof.

18. The processor of claim 16, wherein the known location information is:
provided in a solicited manner using new radio positioning protocol annex (NRPPa) and radio resource control (RRC) request and response signaling;
provided in the solicited manner using long term evolution (LTE) positioning protocol (LPP) request and response signaling;
provided in the solicited manner using LPP providing capability signaling; or
provided in the solicited manner using LPP providing location information signaling.

19. The processor of claim 16, wherein the known location information comprises pre-configured or offline calibration, input, or a combination thereof.

20. The processor of claim 16, wherein the at least one controller is configured to cause the processor to add additional information to a specific DL-PRS resource measurement, wherein the additional information comprises binary or soft indicator values regarding a line-of-sight (LOS) or non-LOS (NLOS) state of the specific DL-PRS resource measurement.
